(19) United States
(12) Patent Application Publication
(10) Pub. No.: US 2024/0263066 A1
(43) Pub. Date: Aug. 8, 2024

(54) SMART NANOFLUIDS FOR GEOTHERMAL APPLICATIONS AND METHODS OF USE

(71) Applicant: THE BOARD OF REGENTS OF THE UNIVERSITY OF OKLAHOMA, Norman, OK (US)

(72) Inventors: Saeed SALEHI, Norman, OK (US); Reza FOUDAZI, Norman, OK (US)

(73) Assignee: THE BOARD OF REGENTS OF THE UNIVERSITY OF OKLAHOMA, (US)

(21) Appl. No.: 18/407,624

(22) Filed: Jan. 9, 2024

Related U.S. Application Data
(60) Provisional application No. 63/479,033, filed on Jan. 9, 2023.

(51) Int. Cl. C09K 8/84; B82Y 30/00; E21B 49/00

(52) U.S. Cl. CPC C09K 8/845; B82Y 30/00; E21B 49/008

(57) ABSTRACT

A method of formulating a nanofluid for use in a geologic formation for determining an average pore size of the geologic formation by selecting a desired flow rate of the nanofluid under a predetermined applied pressure, using the calculated average pore size and desired flow rate to estimate a desired average viscosity of the nanofluid, and producing the nanofluid having the desired average viscosity by combining a quantity of nanoparticles with an aqueous medium. A nanofluid made by said process. A method of treating a geologic formation, such as a geothermal formation, by injecting said nanofluid into the geologic formation.

### CROSS REFERENCE TO RELATED APPLICATIONS

The present application claims priority to U.S. Provisional Application Ser. No. 63/479,033, filed Jan. 9, 2023, the entirety of which is hereby expressly incorporated by reference herein.

### GOVERNMENT SUPPORT

N/A

### BACKGROUND

Enhanced Geothermal Systems (EGS) are engineered underground geothermal reservoirs created where there is hot rock (175-300° C.) but little to no natural permeability and/or fluid saturation [1]. EGS have the capacity to power tens of millions of American homes and businesses. The EGS provides efficient and economically feasible access to enormous clean energy resources. To provide adequate working fluid flow for the economic production flow and optimal heat extraction through the EGS, the reservoir should have a large network of fractures. However, if the fracture network is not uniform, the injected working fluid may take fast pathways where higher conductivity and high injectivity fracture exist, leading to short-circuiting.

During EGS development, subsurface permeability is enhanced via fluid injection, thermal rock-fluid interaction, chemical stimulation, or other safe, well-engineered stimulation processes that re-open pre-existing fractures or create new ones [2]. Successful stimulation in EGS depends on knowledge and characterizing of the subsurface. Tracers are recognized as a powerful method for characterizing the subsurface. In its simplest form, tracer testing can be defined as injecting one or more tracers, usually chemical compounds, into the subsurface in order to estimate its flow and storage properties [3]. Unlike the petroleum industry, the tracer development for the geothermal industry is at infancy levels because of numerous challenges, including high temperatures. There are literature examples of tracer development for geothermal applications. For instance, “a geothermal company in the 1990s conducted a number of tracer tests in a geothermal field. Fluorescein was used as the tracer, and the tests were generally considered a success. Further analysis of test results, however, suggested possible “problems” [3]. The Department of Energy has sponsored some projects in the past for tracer development in the geothermal industry.

Nanofluids, i.e., dispersions of nanoparticles in a liquid, have been proposed as heat transfer fluids. For example, dispersion of a few percent of a nanoparticle in ethylene glycol or oil can increase the thermal conductivity by 40% and 150%, respectively. If the concentration of nanoparticle in the nanofluid is high enough, a shear thickening behavior at high shear rates is observed. For example, Tseng and Wu and Chandrasekar et al. observed a transition from shear thinning or Newtonian behavior to shear thickening behavior for Al₂O₃/water nanofluids at concentrations beyond 2-5% [5-7]. Moldoveanu et al. found that while Al₂O₃ nanofluids have higher viscosity than SiO₂ nanofluids, the latter has stronger shear thickening behavior [8]. Incorporation of nanoparticles into a fluid can affect heat transfer of the fluid by increasing the viscosity of the fluid. It should be noted that only an increase in viscosity by a factor higher than 4 compared to the increase in thermal conductivity can worsen the thermal performance of nanofluid compared to the base fluid [9].

### DETAILED DESCRIPTION

The present disclosure is directed novel stimuli-responsive heat transfer nanofluids and systems for controlling the hydraulic conductivity of EGS reservoirs, and for uses as a tracer fluid. The disclosed nanofluids increase viscosity at high flow velocities in pores and form gels when reaching certain environmental conditions thereby reducing the flow through “fast paths” in the subsurface rock of the reservoir.

The surface properties of nanoparticles control the interparticle interactions in nanofluids and thus the rheological behavior. In the present disclosure, the surface treatment of nanoparticles is adjusted by (1) grafting responsive polymers, and/or (2) functional groups which affect the interparticle interaction of nanoparticles in response to temperature, pH, and/or salinity. Therefore, the disclosed nanofluids not only have enhanced heat transfer (which is essential for geothermal energy resource recovery) but also have responsive behavior in such a way that in response to a stimulus, (a) its non-Newtonian viscosity changes, and (b) it can undergo a sol-gel transition. The disclosed system addresses at least one of the following challenges in geothermal applications: (1) fluids or fluid additives that can increase bulk fluid viscosity if specific fluid flow velocities are reached, reducing mass transport through a targeted fracture network, (2) fluids or fluid additives that can solidify through jamming in small pore or in close proximity to other fluids to control fracture interference and potential “fast paths,” and (3) fluids or fluid additives that can control formation leak-off into the matrix rock.

Before further describing various embodiments of the compositions and methods of the present disclosure in more detail by way of exemplary description, examples, and results, it is to be understood that the embodiments of the present disclosure are not limited in application to the details of methods and compositions as set forth in the following description. The embodiments of the compositions and methods of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the compositions and methods of the present disclosure have been described in terms of particular embodiments, it will be apparent to those of skill in the art that variations may be applied to the compositions and/or methods and in the steps or in the sequence of steps of the method described herein without departing from the spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the composition, the method used to administer the composition, or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The term “about” or “approximately”, where used herein when referring to a measurable value such as an amount, a temporal duration, and the like, is meant to encompass, for example, variations of +20% or +10%, or +5%, or +1%, or +0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. A range of 1 to 20 includes, for example, the numerals 1, 2, 3, 4, 5, 6, 7, 8, 9, 10, 11, 12, 13, 14, 15, 16, 17, 18, 19, and 20, and fractions between each integer, such as indicated above. A range of 6 to 24 includes, for example, the numerals 6, 7, 8, 9, 10, 11, 12, 13, 14, 15, 16, 17, 18, 19, 20, 21, 22, 23, 24, 25, and 26, and fractions between each integer, such as indicated above.

The term “thermal conductivity” as used herein refers to the ability of a material to transfer or conduct heat. It is represented herein by the symbol κ (kappa) and has the units W/(m·K) i.e., watts per (meter×degrees Kelvin). Where used herein, the term “high thermal conductivity” refers to a κ>about 0.8 W/(m·K) up to a level such that viscosity, η, of the nanofluid is less than or equal to 4× the increase in thermal conductivity, κ, of the nanofluid.

The term “viscosity” as used herein refers to a material's resistance to flow. It is represented herein by the symbol η (eta) and has the unit Pa·s (Paschal second). In certain embodiments, the nanofluids of the present embodiments have a viscosity n in a range of about 0.001 Pa·s to about 0.1 Pa·s.

The term “nanoparticle” refers to a particle having a diameter in a range of about 1 nm to about 1000 nm, and more particularly about 1 nm to about 500 nm, and more particularly about 1 nm to about 100 nm.

A particular goal of the present disclosure is to develop smart nano-fluid based tracer and tracer interpretation tools to facilitate robust characterization of temperature distributions and surface area available for heat transfer in EGS. The tracer fluid system disclosed herein is a responsive non-Newtonian nanofluid (TRL 3) prepared by nanoparticles that are dispersed through ultrasonication in aqueous media comprised of, for example, water, electrolytes, alcohols such as glycols (e.g., ethylene glycol (EG), propylene glycol (PG), and glycerol), synthetic polymers such as, polyethylene glycol (PEG), polypropylene glycol (PPG), polyacrylamide (PAM), and polyethylenimine (PEI)), natural polymers such as guar gum and sodium alginate, and non-ionic and ionic surfactants, such as sodium dodecyl sulfate, dodecyltrimethylammonium bromide, Brij™-series non-ionic surfactants, and Pluronic™-type block copolymers (or others listed herein). In at least certain embodiments, the nanoparticles have high thermal conductivity.

The nanoparticles may be, for example, carbon-based nanoparticles (e.g., carbon nanotubes, graphenes, graphene oxide, fullerenes, carbon-based quantum dots, carbon black, and nanodiamonds), ceramic nanoparticles (e.g., alumina (Al₂O₃), silica (SiO₂), titania (TiO₂), zirconia (ZrO₂), calcium sulfate (CaSO₄), calcium carbonate (CaCO₃), calcium phosphate (Ca₂P₂O₇), tricalcium phosphate (Ca₃(PO₄)₂, and hydroxyapatite (Ca₅(OH)(PO₄)₃)), or metal nanoparticles (e.g., Fe, Cu, and Al).

Electrolytes of the aqueous medium may include but are not limited to salts of Na, K, Cl, Ca, Mg, carbonate, phosphate, sulfate, including for example NaCl, KCl, MgCl₂, CaCl₂), MgSO₄, and CaSO₄.

Surfactants that may be used in the present compositions include ionic surfactants (anionic, cationic, and amphoteric) and non-ionic surfactants.

Examples of non-ionic surfactants which may be used herein include, but are not limited to, Alcohol ethoxylates, Polyethoxylated alcohols, Aliphatic alcohol ethoxylates, Alkyl phenol ethoxylates, Fatty acid ethoxylates, Fatty amine ethoxylates, Monoalkanolamide ethoxylates, Sorbitan ester ethoxylates, Ethoxylated fatty alcohols such as Brij™-type surfactants, Ethylene oxide-propylene oxide block copolymers such as Pluronic™-type and Tetronic™-type copolymers, and Alkyl polyglycosides, the following of which are non-limiting examples: Cetomacrogol 1000, Cetostearyl alcohol, Cetyl alcohol, Cocamide DEA, Cocamide MEA, Decyl glucoside, Decyl polyglucose, Glycerol monostearate, IGEPAL® CA-630, Isoceteth-20, Laury! Glucoside, Maltoside, Monolaurin, Mycosubtilin, Nonidet P-40™, Nonoxynol-9, Nonoxynols, NP-40, Octaethylene glycol monododecyl ether, N-Octyl beta-D-thioglucopyranoside, Octyl glucoside, Oleyl alcohol, Pentaethylene glycol monododecyl ether, Polidocanol, Poloxamer, Poloxamer 407, Polyethoxylated tallow amine, Polyglycerol polyricinoleate, Polysorbate, Polysorbate 20, Polysorbate 40, Polysorbate 60, Polysorbate 80, Sorbitan, Sorbitan monolaurate, Sorbitan monostearate, Sorbitan tristearate, Stearyl alcohol, Surfactin, Polyoxyethylene sorbitan esters, Polyoxyethylene sorbitan Octoxynol (Triton X-100™), Polyoxyl castor oil (Cremophor™), and Nonylphenol ethoxylate (Tergitol™).

Examples of ionic surfactants which may be used herein include, but are not limited to, anionic surfactants, cationic surfactants and amphoteric surfactants. Anionic types of surfactants include, for example, Carboxylates, Sulfonates, Petroleum sulfonates, Alkylbenzene sulfonates, Naphthalene sulfonates, Olefin Sulfonates, Sulfates, Alkyl sulfates, Sulfated natural oils and fats, Sulfated esters, Sulfated alkanolamides, and Sulfated alkylphenols. Cationic types of surfactants include, for example, Quaternary ammonium salts, Amines with amide linkages, Polyoxyethylene alkyl amines, Polyoxyethylene alicyclic amines, N,N,N′,N′ Tetrakis substituted ethylenediamines, and Alkyl 1-hydroxyethyl 2-imidazolines. Non-limiting examples of anionic, cationic and amphoteric types of surfactants include the following: Sodium dodecyl sulfate (sodium lauryl sulfate), Sodium laureth sulfate, Lauryl dimethyl amine oxide, Cetyltrimethylammonium bromide (CTAB), Hexadecyltrimethylammonium bromide (HTAB), dodecyltrimethylammonium bromide, Polyoxyl 10, lauryl ether, Bile salts (e.g., sodium deoxycholate, sodium cholate), Methylbenzethonium chloride (Hyamine™), N-Coco 3-aminopropionic acid/sodium salt, N-Tallow 3-Iminodipropionate, disodium salt, N-Carboxymethyl N-dimethyl N-9 octadecenyl ammonium hydroxide, N-Cocoamidethyl N-hydroxyethylglycine, sodium salt, N,N-dimethyldodecylamine-N-oxides, Phosphatidylcholine, and lecithins.

The term alcohol, as used herein, refers to hydroxyl-containing compounds such as mono-ols, diols, and polyols, including, for example, various glycols, cyclitol, aminocyclitol, bornesitol, ciceritol, conduritol, 5-deoxyinositol, ononitol, pinitol, pinpollitol, quebrachitol, inositol, sorbitol, threitol, arabitol, galactitol, iditol, volemitol, fucitol, xylitol, lactitol, erythritol, maltitol, panthenol, mannitol, ethanol, propanol, butanol, pentanol, hexanol, ethynol, 2-heptanol, 3-heptanol, 2-hexanol, 3-hexanol, ribitol, 1,2-butanediol, 1,3-butanediol, 1,4-butanediol, 2,3-butanediol, 2-methyl-2,4-pentanediol, and combinations thereof. Examples of glycols include, for example, ethylene glycol (EG), propylene glycol (PG), glycerol (glycerine), low molecular weight polyethylene glycols (e.g., C2-C10), diethylene glycol, dipropylene glycol, triethylene glycol, ethylene glycol monomethyl ether, glycol monoethyl ether, ethylene glycol monobutyl ether, ethylhexylglycerin, glycerol monostearate, and neopentyl glycol.

The present disclosure includes nanofluids with different concentrations of electrolytes, alcohols, nanoparticles, polymer, and/or surfactants, and different mixtures thereof with different sizes and types of nanoparticles (see above). To control the flow behavior (viscosity and shear thinning/thickening), the composition of nanofluids is varied. Also, nanoparticles with different surface hydrophobicity/hydrophilicity are used. To prepare nanofluids, nanoparticles will be dispersed through ultrasonication in aqueous media comprised of, for example, water, and one or more electrolytes, alcohols, polymer, and surfactants.

The nanofluids can be formulated according to the following steps and parameters: (1) the average pore size of a geologic formation is estimated by injecting a mixture of, for example, an aqueous mixture containing water and EG, into the geologic formation, and measuring the flow rate of the aqueous mixture under applied pressure, (2) based on the calculated average pore size, an average media viscosity for the application is estimated from the required flow rate under applied pressure, (3) the typical volume fraction range of nanoparticles in the nanofluids of the present disclosure is 1 to 9%, wherein the shear thickening behavior is intensified as the volume fraction is increased. The maximum practical volume fraction of the nanofluid is chosen where the increase in viscosity, η, is less than or equal to 4× the increase in thermal conductivity, k,

$$( i . e . , \frac{{η}_{nanofluid}}{{η}_{media}} \leq 4 \frac{{k}_{nanofluid}}{{k}_{media}} ) .$$

Experimental (rheological measurements) and theoretical (e.g., Krieger-Dougherty model) approaches are used to determine viscosity and conductivity of nanofluids, (4) nanofluids with maximum practical volume fraction are prepared, and their flow curve is measured, and (5) the change in flow rate under dynamic change of pressure as well as the change in flow curve, temperature and composition of inlet and outlet nanofluids is used to determine the pore size distribution of rock/formation.

The shear-thickening behavior of nanofluids at high shear rates changes the fluid's response inside the reservoir fracture system. The response can be collected real-time with the injection pressure changes and then interpreted similarly to mini-frac tests to characterize the subsurface. The presence of polymer changes the interparticle interactions and induces the formation of clusters and gelation in nanofluids. High flow rates enhance the cluster formation and physical gelation. The interparticle interactions also change with the concentration of polymer, surfactant, salinity, temperature, and pH. Therefore, different formulations of nanofluids can be used as tracer fluids. The presence of depletants can induce strong depletion attraction, enhancing the potential for gelation. Therefore, nanofluids can transform to gel (undergo sol-gel transition) when reaching a certain salt concentration or pH, both of which can weaken the electrostatic repulsion between particles. The system and nanofluids of the present disclosure enable linkage of the flow pattern inside the fractures to pressure measurements and different responses that can be exploited for subsurface characterization.

### REFERENCES

[1] Holl, H.-G. 2015. “What did we learn about EGS in the Cooper Basin?” ResearchGate, DOI: 10.13140/RG.2.2.33547.49433.
[2] Meier, P. M., Rodríguez, A. and Bethmann, F., 2015, April. Lessons learned from Basel: New EGS projects in Switzerland using multistage stimulation and a probabilistic traffic light system for the reduction of seismic risk. In Proceedings World Geothermal Congress (pp. 19-25).
[3] Shook, G. M., Ansley, S. L. and Wylie, A., 2004. Tracers and tracer testing: design, implementation, and interpretation methods. Bechtel BWXT Idaho, LLC: Idaho National Engineering and Environmental Laboratory.
[4] Keblinski, Pawel, Jeffrey A. Eastman, and David G. Cahill. “Nanofluids for thermal transport.” Materials today 8.6 (2005): 36-44.
[5] Tseng, Wenjea J., and Chun Hsien Wu. “Sedimentation, rheology and particle-packing structure of aqueous Al₂O₃ suspensions.” Ceramics International 29.7 (2003): 821-828.
[6] Tseng, Wenjea J., and Chun Hsien Wu. “Aggregation, rheology and electrophoretic packing structure of aqueous Al₂O₃ nanoparticle suspensions.” Acta Materialia 50.15 (2002): 3757-3766.
[7] Chandrasekar, M., S. Suresh, and A. Chandra Bose. “Experimental investigations and theoretical determination of thermal conductivity and viscosity of Al₂O₃/water nanofluid.” Experimental Thermal and Fluid Science 34.2 (2010): 210-216.
[8] Moldoveanu, Georgiana Madalina, et al. “Viscosity estimation of Al₂O₃, SiO₂ nanofluids and their hybrid: an experimental study.” Journal of Molecular Liquids 253 (2018): 188-196.
[9] Prasher, Ravi, et al. “Measurements of nanofluid viscosity and its implications for thermal applications.” Applied physics letters 89.13 (2006): 133108.

What is claimed is:

1. A method of formulating a nanofluid, the method comprising the steps of:
determining an average pore size of the geologic formation;
selecting a desired flow rate of the nanofluid under a predetermined applied pressure;
using the calculated average pore size and desired flow rate to estimate a desired average viscosity of the nanofluid; and
producing the nanofluid having the desired average viscosity by combining a quantity of nanoparticles with an aqueous medium wherein the volume fraction of nanoparticles in the nanofluid is in a range of about 1% to about 9%, wherein the shear thickening behavior of the nanofluid is intensified as the volume fraction is increased, and wherein the volume fraction of the nanoparticles in the nanofluid is determined such that the relationship
$$\frac{{η}_{nanofluid}}{{η}_{media}} \leq 4 \frac{{k}_{nanofluid}}{{k}_{media}}$$
is satisfied, wherein η_{nanofluid} is the viscosity of the nanofluid, η_{media} is the viscosity of the aqueous medium, k_{nanofluid} is the thermal conductivity of the nanofluid, and k_{media} is the thermal conductivity of the aqueous medium.

2. The method of claim 1, wherein the average pore size of the geologic formation is estimated by injecting the aqueous medium into the geologic formation and measuring a flow rate of the aqueous medium under an applied pressure.

3. The method of claim 1, comprising measuring the flow curve of the nanofluid.

4. The method of claim 1, comprising injecting the nanofluid into the geologic formation and determining a pore size distribution of the geologic formation.

5. The method of claim 1, wherein the nanoparticles are selected from carbon-based nanoparticles, ceramic nanoparticles, and metal nanoparticles.

6. The method of claim 5, wherein the carbon-based nanoparticles are selected from carbon nanotubes, graphenes, graphene oxide, fullerenes, carbon-based quantum dots, carbon black, and nanodiamonds.

7. The method of claim 5, wherein the ceramic nanoparticles are selected from alumina, silica, titania, zirconia, calcium sulfate, calcium carbonate, calcium phosphate, tricalcium phosphate, and hydroxyapatite.

8. The method of claim 5, wherein the metal nanoparticles are selected from Fe, Cu, Al, and Zn nanoparticles.

9. The method of claim 1, wherein the nanoparticles have a thermal conductivity k in a range of about 0.8 W/mK up to a level such that viscosity, η_{nanofluid}<4× the increase in k_{nanofluid}.

10. The method of claim 1, wherein the aqueous medium comprises water and at least one component selected from an electrolyte, an alcohol, an ionic surfactant, a non-ionic surfactant, and a polymer.

11. The method of claim 10, wherein the electrolyte of the aqueous medium is selected from salts of Na, K, Cl, Ca, Mg, carbonate, phosphate, and sulfate.

12. The method of claim 10, wherein the polymer of the aqueous medium is selected from synthetic polymers and natural polymers.

13. The method of claim 10, wherein the alcohol of the aqueous medium is selected from glycols, mono-ols, diols, and polyols.

14. The method of claim 13, wherein the diol is a glycol.

15. The method of claim 1, wherein the geologic formation is a geothermal formation.

16. A method of treating a geologic formation, comprising injecting the nanofluid of claim 1 into the geologic formation.

17. The method of claim 16, wherein the geologic formation is a geothermal formation.

18. A nanofluid made by the process of:
determining an average pore size of a geologic formation;
selecting a desired flow rate of the nanofluid under a predetermined applied pressure;
using the calculated average pore size and desired flow rate to estimate a desired average viscosity of the nanofluid; and
producing the nanofluid having the desired average viscosity by combining a quantity of nanoparticles with an aqueous medium wherein the volume fraction of nanoparticles in the nanofluid is in a range of about 1% to about 9%, wherein the shear thickening behavior of the nanofluid is intensified as the volume fraction is increased, and wherein the volume fraction of the nanoparticles in the nanofluid is determined such that the relationship
$$\frac{{η}_{nanofluid}}{{η}_{medla}} \leq 4 \frac{{k}_{nanofluid}}{{k}_{media}}$$
is satisfied, wherein η_{nanofluid} is the viscosity of the nanofluid, η_{media} is the viscosity of the aqueous medium, k_{nanofluid} is the thermal conductivity of the nanofluid, and k_{media} is the thermal conductivity of the aqueous medium.

19. The nanofluid of claim 18, wherein the geologic formation is a geothermal formation.
